(19) United States
(12) Patent Application Publication
(10) Pub. No.: US 2009/0181341 A1
(43) Pub. Date: Jul. 16, 2009

(54) Endodontic Instrument

(76) Inventor: Chris J. Lampert, (US)

Correspondence Address: Chris J. Lampert, Suite 300, 5440 SW Westgate Drive, Portland, OR, 97221, US

(21) Appl. No.: 12/352,889

(22) Filed: Jan. 13, 2009

Related U.S. Application Data
(60) Provisional application No. 61/010,949, filed on Jan. 14, 2008.

(51) Int. Cl. A61C 5/02

(52) U.S. Cl. 433/102

(57) ABSTRACT

An endodontic instrument for root canal treatment is provided having a working portion manipulated by a handle and a curved radiused connection site for the attachment of an electronic apex locator. The curved radiused connection site is located at the proximal end of the file handle and allows the electronic apex locator to be connected to the endodontic instrument at any desirable angle.

This application claims the benefit of and priority to U.S. Provisional Application No. 61/010,949, entitled “Endodontic Instrument”, filed Jan. 14, 2008, the entire disclosure of which is hereby incorporated by reference as if set forth in their entirety for all purposes.

### FIELD OF THE INVENTION

This invention relates generally to endodontic instruments for performing root canal procedures and, more particularly, to a connection assembly for electrically connecting an endodontic file to an electronic apex locator.

### BACKGROUND OF THE INVENTION

Traditional endodontic files consist of a tapered cutting flute portion having a shaft connected to a handle that is gripped by a user such as, for example, a dentist or an endodontist. Endodontic files have cutting flutes on the working portion and are used to remove the contents of a root canal and to prepare and/or shape the root canal prior to filling it. Endodontic files are also used to determine the length of the root canal by connecting an electronic apex locator to the endodontic file. An electronic apex locator is an electronic measuring device used to determine the length of root canals.

FIG. 1 shows a traditional endodontic file 10 with tapered cutting flutes 12 located at one end of a shaft 14 secured to a handle 16 that is grasped by a user to perform the root canal procedure. Typically, shaft 14 is connected to a distal end 18 of handle 16 and the user grasps handle 16 to perform the root canal procedure. The proximal end of the handle 16 is noted by point 20.

For all currently available endodontic files on the market, an electronic apex locator must attach to the file shaft 14 located between the file handle 16 and the tapered cutting flutes 12. As seen in FIG. 2, an electronic apex locator (not shown) is connected to the prior art endodontic file 10 by a customary electrically conductive clip or other mechanism 22 attached to shaft 14 between tapered cutting flutes 12 and handle 16 in order to measure the length of the root canal. Clip 22 is connected to the apex locator by an electrically conductive wire 23 and tapered cutting flutes 12 and shaft portion 14 are made of an electrically conductive material so that electrical signals can be sent from tapered cutting flutes 12 to the apex locator. One problem of the prior art assembly shown in FIG. 2 is that clip 22 is typically attached to shaft 14 between tapered cutting flutes 12 and handle 16 forming a 90° angle lever on shaft 14.

This location of attachment of clip 22 to shaft 14 is undesirable because it impairs visibility. Additionally, unwanted lateral forces may be imparted to shaft 14. Such forces impair the dexterity of file manipulation and impair the angle of file insertion into the root canal.

Endodontic instruments are also shown and described in U.S. Pat. Nos. 4,260,379 (Groves et al.), 4,332,561 (McSpadden), 6,520,773 (Weber), 3,916,529 (Mousseau), 6,872,075 (Regan), 7,121,827 (Lampert), 4,824,369 (Levy), 5,112,224 (Shirota), 5,213,499 (Levy), and 5,775,903 (Atkins), and Buchanan (4,836,780), the entire disclosures of which patents are hereby incorporated by reference as if set forth in their entirety for all purposes.

### SUMMARY OF THE INVENTION

The present invention provides an endodontic file that overcomes difficulties associated with currently available endodontic instruments and electronic apex locator attachment. Specifically, the present invention provides an endodontic file having an improved connection site for an electronic apex locator.

The endodontic file of the present invention includes a connection site located at the proximal end of the file handle opposite the tapered cutting flutes which has a radius or curved portion which allows for an apex locator to be connected at any angle along the curved radius desired by the dentist. The curved radius connection site makes electrical contact with the file shaft to allow for electrical signals to flow from the file shaft to the electronic apex locator. The curved radius connection site may also be an extension of the file shaft which passes through the file handle and forms a curved arcing radius to which an electronic apex locator may be attached.

The electronic apex locator connection assembly of this invention improves dexterity of file manipulation, improves visibility, improves tactile feedback, allows the electronic apex locator to be attached to the file at multiple angles along the curved radius. These improvements make root canal procedures more accurate and efficient for both the dentist and the patient.

As another embodiment consistent with improving the connection between an electronic apex locator and an endodontic file, a magnetized connection assembly can be used to magnetically couple the apex locator lead to the endodontic file. For example, the distal end of the apex locator lead can be magnetized and magnetically attach to the file shaft or to a metallic structure on the file handle. As another example the file handle can have a magnetic structure and magnetically attach to a metallic structure on the distal end of the apex locator lead. As yet another example, both the endodontic file and the apex locator lead can be magnetic and connect to each other. Preferably a small magnet would be attached to the proximal end of the files handle and make electrical contact with the files working shaft.

These and other embodiments are described in more detail in the following description of the drawings and detailed description of the invention.

### BRIEF DESCRIPTION OF THE DRAWINGS

FIG. 1 is an illustration showing a traditional prior art endodontic instrument.

FIG. 2 is an illustration similar to FIG. 1 showing a traditional prior art electronic apex locator attached to the endodontic instrument.

FIG. 3 is a view of the inventive endodontic instrument showing the radius apex locator connection site.

FIG. 4 is a view of the endodontic instrument of FIG. 3 showing an electronic apex locator connected to the radius connection site.

FIG. 5 is a view of the endodontic instrument in FIG. 3. showing an electronic apex locator connected to the radius connection site at another angle.

FIG. 6 is a view of the endodontic instrument in FIG. 3. showing an electronic apex locator connected to the radius connection site at another angle.

FIG. 7 is a view of the endodontic instrument in FIG. 3. showing an electronic apex locator connected to the radius connection site at another angle.

FIG. 8 is a view of the endodontic instrument in FIG. 3. showing an electronic apex locator connected to the radius connection site at another angle.

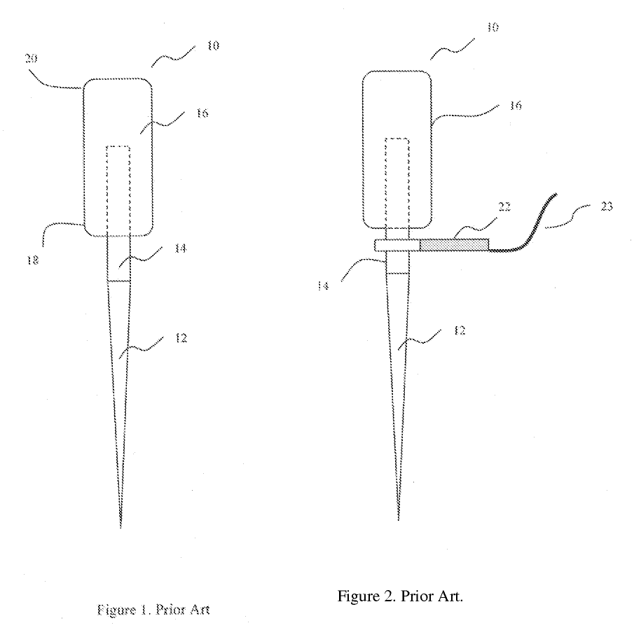

### DETAILED DESCRIPTION OF THE INVENTION

The inventive endodontic file 40 is shown in FIG. 3 having a connection site 48 for an electronic apex locator wherein the connection site is located on the proximal end of the file handle and has a radius or curved shape which allows the electronic apex locator to be connected at any angle along the radius. Endodontic file 40 is shown as an elongate element having tapered cutting flutes 42 comprising a working end for insertion into a root canal (not shown) and a shaft 44 secured to a handle 46 to be grasped by a user. Handle 46 is secured by any convenient means to shaft 44, for example handle 46 may be an injection molded plastic handle which is molded around shaft 44. Shaft 44 extends in a continuous fashion through handle 46 and out the proximal end of handle 46 and forms a curved radius 48.

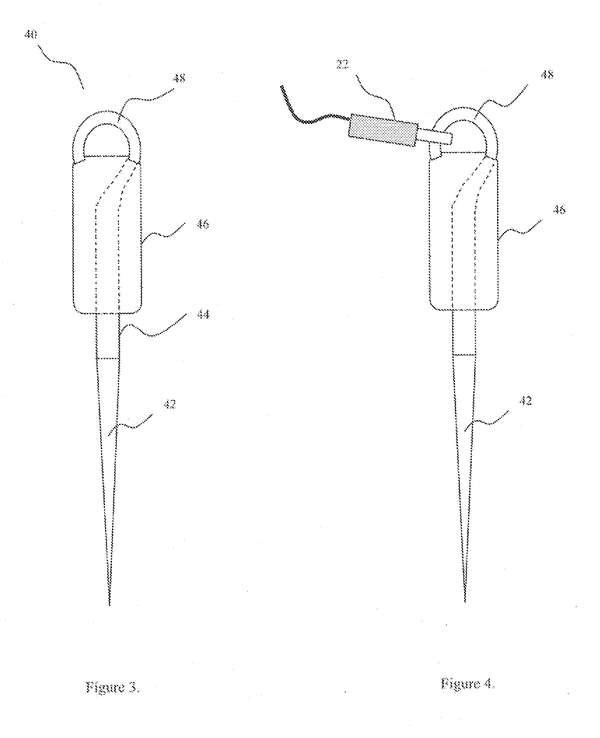

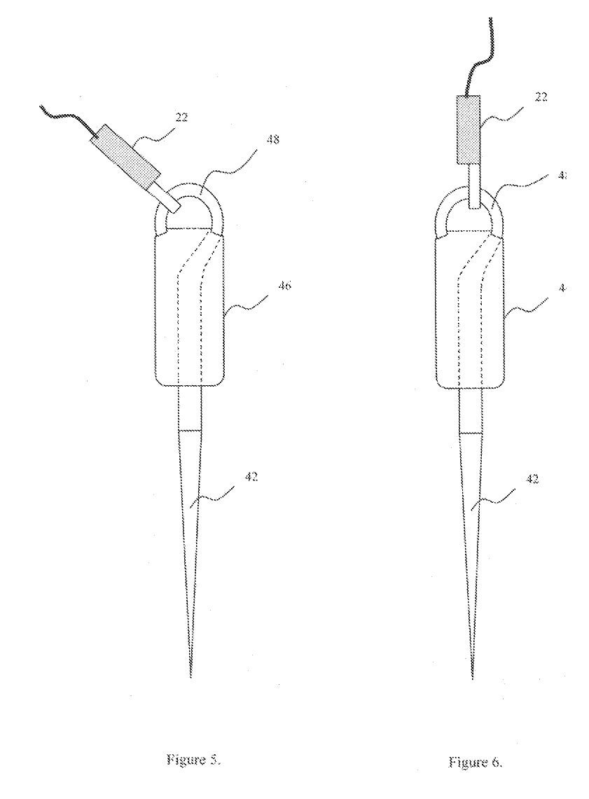

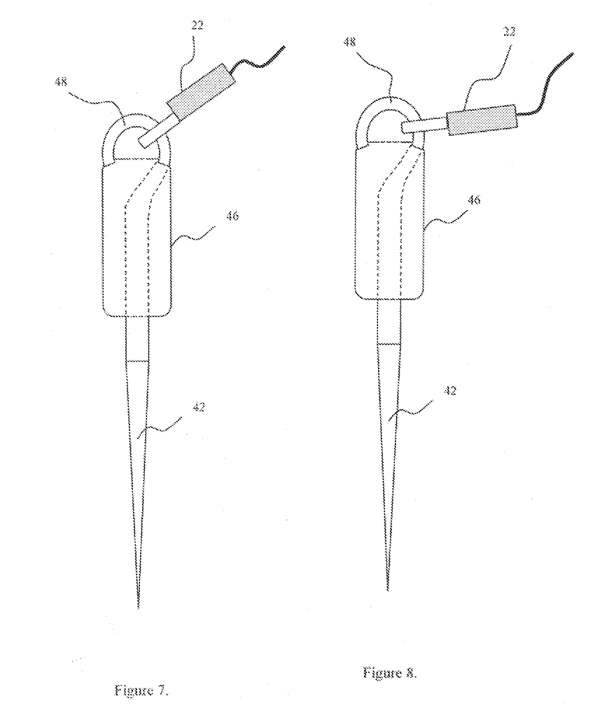

As shown in FIG. 4 the curved radius connection site 48 allows for an electronic apex locator 22 to be connected at any desirable angle along the curved radius. FIGS. 5, 6, 7, and 8 show examples of how an electronic apex locator 22 can be connected to the curved radius connection site 48 at various angles.

Although the embodiments of the present invention are shown and described as being related to endodontic instruments for measuring the length of a root canal, it is understood that this invention contemplates other uses such as, for example, measuring and/or sensing other conditions at a surgical site. This may be accomplished by utilizing an electronic or other type of sensor located in or on the endodontic instrument that receives and/or sends electronic or other signals to a monitoring device through a connection assembly as disclosed herein.

The present invention greatly improves the use of an endodontic file with an electronic apex locator by an improved connection therebetween. The improved curved radius connection site between the endodontic file and electronic apex locator allows for greater dexterity when manipulating the file, provides improved visibility of the root canal and file, allows the electronic apex locator to be attached to the file at multiple angles, and provides for a more accurate measurement of the root canal. Additionally, the present invention improves the use of the endodontic file with an electronic apex locator by improving tactile feedback.

Persons skilled in the art will recognize that many modifications and variations are possible in the details, materials, and arrangements of the parts and actions which have been described and illustrated in order to explain the nature of this invention; and that such modifications and variations do not depart from the spirit and scope of the teachings and claims contained therein.

What is claimed:

1. An endodontic instrument used in performing a root canal procedure, comprising: an element extending along an axis having a distal working portion for insertion into the root canal of a tooth and a handle to be grasped by a user, and a curved radiused connection site for an electronic apex locator which is located on the proximal end of the instrument handle.

2. The endodontic instrument in claim 1, wherein an electronic apex locator can be attached at any desired angle along the curved radius.

3. The endodontic instrument in claim 1, wherein the curved radiused connection site for an electronic apex locator makes electrical contact with the file shaft and the instruments working portion.

4. The endodontic instrument in claim 1, wherein the curved radiused connection site for an electronic apex locator is an extension of the file shaft which passes through the instruments handle.

5. The endodontic instrument in claim 1, wherein electrical signals are transmitted from the curved radiused connection site through the instrument handle to the distal working portion.

6. An endodontic instrument used in performing a root canal procedure, comprising: an element extending along an axis having a distal working portion for insertion into the root canal of a tooth and a handle to be grasped by a user, wherein a magnetic connection assembly is used to connect an apex locator lead to the endodontic instrument.

7. The endodontic instrument in claim 6, wherein the apex locator lead has a magnetized portion which is magnetically attached to a metallic structure on the endodontic instruments handle.

8. The endodontic instrument in claim 6, wherein the apex locator lead has a magnetized portion which is magnetically attached to another magnetized structure on the endodontic instruments handle.

9. The endodontic instrument in claim 6, wherein the endodontic instrument has a magnetized portion and attaches to a metallic structure on the apex locator lead.
